(19) United States
(12) Patent Application Publication
(10) Pub. No.: US 2023/0394413 A1
(43) Pub. Date: Dec. 7, 2023

(54) GENERATIVE ARTIFICIAL INTELLIGENCE FOR EXPLAINABLE COLLABORATIVE AND COMPETITIVE PROBLEM SOLVING

(71) Applicant: SRI International, Menlo Park, CA (US)

(72) Inventors: Subhodev Das, Princeton, NJ (US); Aswin Nadamuni Raghavan, Pennington, NJ (US); Avraham Joshua Ziskind, Cherry Hill, NJ (US); Timothy J. Meo, Kendall Park, NJ (US); Bhoram Lee, Princeton, NJ (US); Chih-hung Yeh, Alameda, CA (US); John Cadigan, San Diego, CA (US); Ali Chaudhry, Princeton Junction, NJ (US); Jonathan C. Balloch, Atlanta, GA (US)

(21) Appl. No.: 18/330,930

(22) Filed: Jun. 7, 2023

Related U.S. Application Data
(60) Provisional application No. 63/349,856, filed on Jun. 7, 2022.

(51) Int. Cl. G06Q 10/0637

(52) U.S. Cl. CPC G06Q 10/06375

(57) ABSTRACT

In general, the disclosure describes techniques for Artificial Intelligence (AI) models that can automatically generate diverse, explainable, interpretable, reactive, and coordinated behaviors for a team. In an example, a method includes receiving multimodal input data within a simulator configured to simulate solving a predefined problem by a team including a plurality of agents; generating one or more generative neural network models based on the multimodal input data and based on a predetermined threshold of success of problem solving in the simulator; outputting, by the one or more generative neural network models, one or more multi-agent controllers, wherein each of the one or more multi-agent controllers comprises recommended behaviors for each of the plurality of agents to solve the predefined problem in a manner that is consistent with the multimodal input data.

This application claims the benefit of U.S. Patent Application No. 63/349,856, filed Jun. 7, 2022, which is incorporated by reference herein in its entirety.

### GOVERNMENT RIGHTS

This invention was made with Government support under contract number HR00112090114, awarded by DARPA. The Government has certain rights in the invention.

### TECHNICAL FIELD

This disclosure is related to artificial intelligence systems, and more specifically to generative artificial intelligence for explainable collaborative and competitive problem solving.

### BACKGROUND

In the process of solving a complex problem, it is a common practice to decompose the problem into a set of smaller sub-problems, each of which may be solved independently, for example, using a sequential decision-making process. However, when the problem is solved by heterogeneous Artificial Intelligence (AI) agents, who can both cooperate with each other as well as compete with each other, typically, no restrictions are imposed on the relationships among the agents. Such heterogeneous AI agents may interact in a shared environment with conflicting goals. Furthermore, such AI agents may try to solve the assigned sub-problems or tasks using multiple inputs, such as, but not limited to, perception of the environment, history of actions, interactions with neighboring agents, and the like.

The aforementioned environment of heterogeneous AI agents does not guarantee attaining the goal with traditional AI search techniques because of the uncertainty of the environment. In such heterogeneous environment, a policy or a set of state-action “rules” is typically required to guide the AI agents. Such policy may be formulated as a Multi-Agent Reinforcement Learning (MARL) problem in which an agent observes the behavior of other agents in addition to its own outcomes and learns a policy or a set of state-action “rules” to reach its goal. In such environment, it is often difficult for AI agents to learn the optimal policy contributing to a set of actions because goals of various AI agents are not always aligned.

The learning objective to solve MARL problem becomes multidimensional, hence convergence of the policy learning cannot be guaranteed. Capabilities of AI agents to improve their policies according to their own rewards concurrently lead to the non-stationary environment encountered by each agent. As a result, the estimated potential reward of an agent's action becomes inaccurate. In other words, good policies at a given point in time may not remain ideal in the future. Furthermore, since the joint action space increases exponentially with the number of AI agents, the combinatorial nature of MARL problem leads to scalability issues.

### SUMMARY

In the process of solving MARL problem, the information structure may be complex, as each AI agent has partial observability or limited access to the observations of others, leading to possibly suboptimal decision rules locally. Reinforcement Learning (RL) has been applied in many fields such as, but not limited to, autopilots, robotics, gaming, and the like. The adoption of RL in real-time strategy (RTS) games such as AlphaStar, StarCraft and Dota2 would require millions of expert demonstrations followed by a long phase of RL training. Strategy space in these games is fairly large. For example, Starcraft has 10²⁶ atomic actions at every time step. However, such RL-based strategy games do not produce explainable policies.

In general, the disclosure describes AI models that can automatically generate diverse, explainable, interpretable, reactive, and coordinated behaviors for a team composed of agents. For example, the generated behaviors may be represented as multi-agent controllers. Multi-agent controllers may solve problems collaboratively by communicating with each other and sharing information. Such collaboration allows the agents to coordinate their actions and work together to achieve a common goal. The disclosed AI models are directly optimized to output multi-agent controllers by one of the following methods: “Stateless” generator; “Reactive” generator; and “Inductive” generator. These AI models may optimize for general utility functions, which may be reasonably approximated by a quadratic utility function (i.e., mean-variance utility).

The techniques may provide one or more technical advantages that realize at least one practical application. Many modern problems require a team to solve a task in a collaborative problem solving manner. Current practice may require a human to assign explicit sub-tasks and multiple resources to team members (agents) and may engineer the coordination between them. Such practice can be both expensive and time consuming. The disclosed techniques simplify collaborative problem solving by optimizing overall team performance rather than optimizing individual agent's completion of a given task. In other words, the disclosed techniques may enable collaborative problem solving such as, but not limited to, multimodal cognitive communications, collaboration, consultation and instruction between and among heterogeneous networked teams of persons, machines, devices, neural networks, robots and the like (collectively, “agents”). As used herein, the terms “problem solving” and a “solution to the problem” refer to merely selecting a solution to the problem having the higher probability of successfully solving the problem. Such solution is selected by one or more AI models from a plurality of solutions considered by the one or more AI models. The different types of multi-agent controllers generated by the disclosed machine learning model may capture diverse, explainable, coordinated behavior of a team. Once a problem to be solved is represented as a Deep Reinforcement Learning (DRL) problem, the machine learning model may employ one or more Deep Neural Networks (DNNs) to output a probability distribution over the generated multi-agent controllers. Such DNNs may be processed in parallel on multiple multi-core processors and may be optimized using, as examples, simulations or natural language guidance.

In an example, a machine learning system for generating team behaviors comprises: an input device configured to receive multimodal input data within a simulator configured to simulate solving a predefined problem by a team comprising a plurality of agents; processing circuitry and memory for executing a machine learning system, wherein the machine learning system is configured to generate one or more generative neural network models based on the multimodal input data and based on a predetermined threshold of success of problem solving in the simulator; and an output device configured to output one or more multi-agent controllers, wherein each of the one or more multi-agent controllers comprises recommended behaviors for each of the plurality of agents to solve the predefined problem in a manner that is consistent with the multimodal input data.

In an example, a method includes receiving multimodal input data within a simulator configured to simulate solving a predefined problem by a team comprising a plurality of agents; generating one or more generative neural network models based on the multimodal input data and based on a predetermined threshold of success of problem solving in the simulator; outputting, by the one or more generative neural network models, one or more multi-agent controllers, wherein each of the one or more multi-agent controllers comprises recommended behaviors for each of the plurality of agents to solve the predefined problem in a manner that is consistent with the multimodal input data.

In an example, a non-transitory computer-readable medium comprises machine readable instructions for causing processing circuitry to perform operations comprising: receiving multimodal input data within a simulator configured to simulate solving a predefined problem by a team comprising a plurality of agents; generating one or more generative neural network models based on the multimodal input data and based on a predetermined threshold of success of problem solving in the simulator; outputting, by the one or more generative neural network models, one or more multi-agent controllers, wherein each of the one or more multi-agent controllers comprises recommended behaviors for each of the plurality of agents to solve the predefined problem in a manner that is consistent with the multimodal input data.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating example system in accordance with the techniques of the disclosure.

FIG. 2 is a block diagram illustrating conversion, by a semantic parser, of natural language sentences in multimodal input data into Intermediate Representations (TRs) of constraints and/or procedures, according to techniques of this disclosure.

FIG. 3 is a block diagram illustrating multi-agent controllers represented as behavior trees, wherein each of behavior tree comprises recommended behaviors, consistent with the multimodal input data, according to techniques of this disclosure.

FIG. 4 is a flow chart illustrating optimization of the generated plurality of multi-agent controllers, using a simulation engine, according to techniques of this disclosure.

FIG. 5 is an example of a computing system, according to techniques of this disclosure.

FIG. 6 is a flowchart illustrating an example mode of operation for a machine learning system, according to techniques described in this disclosure.

Like reference characters refer to like elements throughout the figures and description.

### DETAILED DESCRIPTION

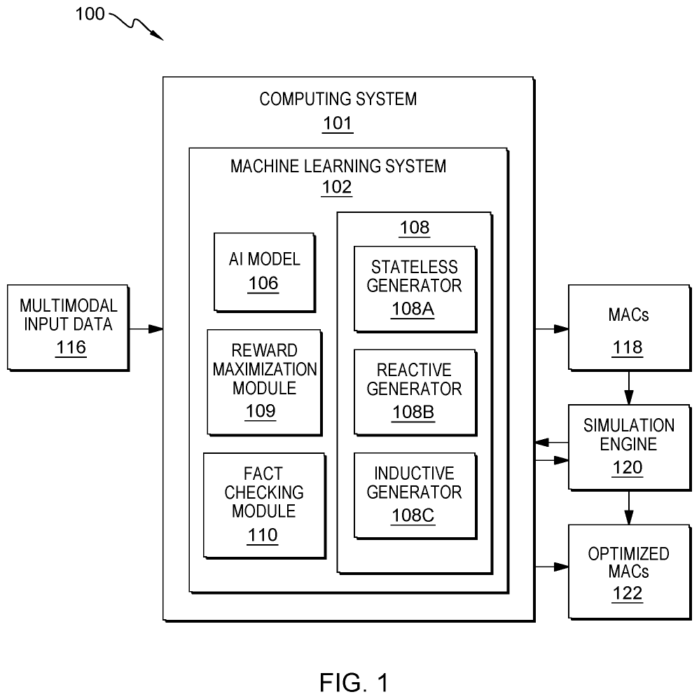

FIG. 1 is a block diagram illustrating example system 100 in accordance with the techniques of the disclosure. As shown, system 100 includes computing system 101 and simulation engine 120.

Computing system 101 executes machine learning system 102, which may be implemented as software, but may in some examples include any combination of hardware, firmware, and software. Machine learning system 102 may optionally train AI model 106.

Computing system 101 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 101 may represent a cloud computing system, server farm, and/or server cluster (or portion thereof) that provides services to client devices and other devices or systems. In other examples, computing system 101 may represent or be implemented through one or more virtualized compute instances (e.g., virtual machines, containers, etc.) of a data center, cloud computing system, server farm, and/or server cluster.

Machine learning system 102 may further include one or more generative AI models. In an aspect, the generative AI models may include one or more Multi-Agent Controller (MAC) generators 108A-108C (collectively, “MAC generators 108”). For example, MAC generators 108 may include, but are not limited to, stateless generator 108A, reactive generator 108B, and inductive generator 108C. Each of AI model 106 and MAC generators 108 may represent a different machine learning model. In an aspect, MAC generators 108A-108C may combine to form overall MAC generation machine learning model 108 implemented by machine learning system 102. In an aspect, machine learning system 102 may include a reward maximization module 109 and a fact checking module 110. In an aspect, the reward maximization module 109 may be configured to provide long term optimization of team behavior, and the fact checking module 110 may be configured to optimize MACs such that they obey general guidance (e.g., generic guidance over scenario/team/agent) given in natural language, as discussed in greater detail below in conjunction with FIG. 4. In an aspect, the reward maximization module 109 may select optimal agents for a particular task based on contextual information about agents, environment and intent (e.g., a problem that needs to be solved by a team). In an aspect, the fact checking module 110 may be used to ensure the accuracy of the information that is processed or generated.

Stateless generator 108A may be configured to create MACs without any perceptual inputs from one or more agents. Stateless generator 108A may be implemented to produce optimized diverse MACs that maximize the utility (or reward) of a team, when the generated team behavior is run till termination without any interruptions by the simulation engine 120. Reactive generator 108B may be configured to create MACs based on a range of perceptual inputs from one or more agents. Reactive generator 108B may be implemented to interrupt the simulation of the generated team behavior and regenerate one or more team behaviors when needed to produce an optimized team behavior. As used herein, the term “optimized behavior” refers to behavior that is more likely to solve a given problem in the most efficient way. In an aspect, perceptual inputs may include interactions between different agents, for example. It should be noted that reactive generator 108B is merely semi-autonomous, which reflects resource limits of reactive generator 108B. Inductive generator 108C could be a stateless MAC generator similar to the stateless generator 108A. However, inductive generator 108C may be implemented to generate optimized MACs such that they obey a specific set of natural language instructions.

In one non-limiting example, computing system 101 maybe a rescue support system that may be used by a rescue team in emergency situations. In an aspect, MACs generated by machine learning system 102 may include Courses of Action (COA) for one or more agents. To evaluate the modeled behaviors in emergency situations in the simulation engine 120, emergency conditions may be incorporated into the simulation, for example. In an aspect, machine learning system 102 may generate one or more feasible COAs (e.g., in the form of multi-agent controllers 118), identify optimal COAs and may provide reasoning to support recommended optimal COAs. Advantageously, a rescue support system using machine learning system 102 may be capable of evolving from current hazards to future potential hazards based on continuous assessment of risk to rescuers.

Whereas machine learning system 102 may be configured specifically to be used by a rescue support system, aspects of the disclosure described herein may be implemented in many different systems. For example, machine learning system 102 may be used in a multi-robotic system (MRS). As another non-limiting example, machine learning system 102 may be used in operating a fleet of autonomous vehicles (i.e., cars, trucks, or trains). As yet another non-limiting example, machine learning system 102 may be used in smart grids (e.g., a grid of traffic lights in smart cities), among many other applications.

Simulation engine 120 may be implemented as any suitable computing system, such as one or more server computers, workstations, laptops, mainframes, appliances, cloud computing systems, smart phones, tablet computers, and/or other computing systems that may be capable of performing operations and/or functions described in accordance with one or more aspects of the present disclosure. In some examples, simulation engine 120 may represent a cloud computing system, server farm, and/or server cluster (or portion thereof) that provides services to client devices and other devices or systems. In other examples, simulation engine 120 may represent or be implemented through one or more virtualized compute instances (e.g., virtual machines, containers) of a data center, cloud computing system, server farm, and/or server cluster.

Computing system 101 and simulation engine 120 may be the same computing system or different systems connected by a network. One or more networks connecting any of the systems of system 100 may be the internet or may include, be a part of, and/or represent any public or private communications network or other network. For instance, the network may each be a cellular, Wi-Fi®, ZigBee, Bluetooth® (or other personal area network—PAN), Near-Field Communication (NFC), ultrawideband, satellite, enterprise, service provider, and/or other type of network enabling transfer of data between computing systems, servers, and computing devices. One or more of client devices, server devices, or other devices may transmit and receive data, commands, control signals, and/or other information across the networks using any suitable communication techniques.

Early work on Artificial Intelligence (AI) focused on Knowledge Representation and Reasoning (KRR) through the application of techniques from mathematical logic. The compositionality of KRR techniques provides expressive power for capturing expert knowledge in the form of rules or assertions (declarative knowledge), but they are brittle and unable to generalize or scale. Recent work has focused on Deep Learning (DL), in which the parameters of complex functions are estimated from data. Deep learning techniques learn to recognize patterns not easily captured by rules and generalize well from data, but they often require large amounts of data for learning and in most cases do not reason at all.

In the process of solving a complex problem, it is a common practice to decompose the problem into a set of smaller sub-problems, each of which may be solved independently, for example, using a sequential decision-making process. However, when the problem is solved by heterogeneous AI agents, who can both cooperate with each other as well as compete with each other, typically, no restrictions are imposed on the relationships among the agents. Such heterogeneous AI agents may interact in a shared environment with conflicting goals. Furthermore, such AI agents may try to solve the assigned sub-problems or tasks using multiple inputs, such as, but not limited to, perception of the environment, history of actions, interactions with neighboring agents, and the like.

The aforementioned environment of heterogeneous AI agents does not guarantee attaining the goal with traditional AI search techniques because of the uncertainty of the environment. In such heterogeneous environment, a policy or a set of state-action “rules” is typically required to guide the AI agents. Such policy may be formulated as a MARL problem in which an agent observes the behavior of other agents in addition to its own outcomes and learns a policy or a set of state-action “rules” to reach its goal. In such environment, it is often difficult for AI agents to learn the optimal policy contributing to a set of actions because goals of various AI agents are not always aligned.

The learning objective to solve MARL problem becomes multidimensional, hence convergence of the policy learning cannot be guaranteed. Capabilities of AI agents to improve their policies according to their own rewards concurrently lead to the non-stationary environment encountered by each agent. As a result, the estimated potential reward of an agent's action becomes inaccurate. In other words, good policies at a given point in time may not remain ideal in the future. Furthermore, since the joint action space increases exponentially with the number of AI agents, the combinatorial nature of MARL problem leads to scalability issues.

One of the biggest challenges for reinforcement learning is sample efficiency. Once a MARL agent is trained, it can be deployed to act in real-time by only performing an inference through the trained model (e.g., via a neural network). However, pure planning methods such as Monte Carlo tree search (MCTS) do not have an offline training phase, but they perform computationally costly simulation based rollouts (assuming access to a simulator) to find the best action to take. In other words, MARL systems might require millions of expert demonstrations followed by a long phase of RL training.

In accordance with techniques of this disclosure, machine learning system 102 generates diverse, interpretable and explainable solutions. A user of system 100 may provide multimodal input data 116 to computing system 101 for processing. Multimodal input data 116 may include one or more sequences of steps to be executed to complete a task (work task, for example). As another example, in emergency situation context, multimodal input data 116 may be damage assessment, various paths to reach one or more victims, operation orders (a formatted directive that a team leader issues to his/her subordinates describing the actions and tasks required to execute the selected COA), and the like. The term “multimodal input data” or “multimodal data” is used herein to refer to information that may be composed of a plurality of media or data types such as, but not limited to, video, audio, graphics, temperature, pressure and other sensor measurements. In an aspect, multimodal input data may include, but is not limited to descriptive text, intent, logical model, and the like.

In an aspect, machine learning system 102 may apply an AI model 106 to multimodal input data 116 to automatically convert contextual meaning of natural language statements contained in the multimodal input data 116 into a concise formal representation, as described in greater detail below. In an aspect, AI model 106 may employ a semantic parser to parse multimodal input data 116.

AI model 106 may include one or more neural network models, each made up of a neural network having one or more parameterized layers. Example neural networks can include a convolutional neural network (CNN), a deep neural network (DNN), a recurrent (or “recursive”) neural network (RNN), or a combination thereof. An RNN may be based on a Long Short-Term Memory cell.

In examples in which the AI model 106 includes layers, each of the layers may include a different set of artificial neurons. The layers can include an input layer, an output layer, and one or more hidden layers (which may also be referred to as intermediate layers). The layers may include fully connected layers, convolutional layers, pooling layers, and/or other types of layers. In a fully connected (or “dense”) layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer. Each input of each artificial neuron in each of the layers may be associated with a corresponding weight, and artificial neurons may each apply an activation function known in the art, such as Rectified Linear Unit (ReLU), TanH, Sigmoid, etc.

In the example of FIG. 1, MAC generation machine learning model 108 may include one or more DNNs. Each DNN may include a sequence of multiple subnetworks arranged from a lowest subnetwork in the sequence to a highest subnetwork in the sequence. MAC generation machine learning model 108 may process received multimodal input data 116 through each of the subnetworks in the sequence to generate one or more MACs corresponding to the multimodal input data 116.

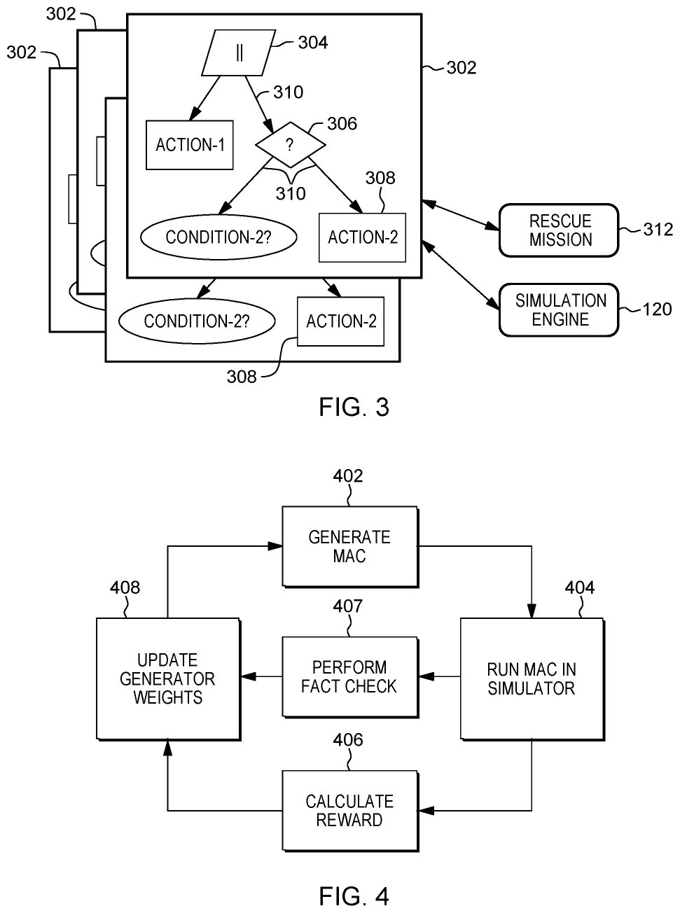

In an aspect, each MAC may comprise a behavior tree (BT). Furthermore, MAC generation machine learning model 108 may comprise a Behavior Tree Generative Adversarial Network (BT-GAN) that can generate diverse BTs. The BT-GAN may include a generator G and a discriminator D. The generator, G, takes a vector z, sampled from random Gaussian noise or conditioned with multimodal input, and transforms the noise to p_{G}=G(z) to mimic the data distribution, N_{data}. Batches of the generated (fake) data and real behavior are sent to the discriminator, D, where the discriminator assigns a label 0 for real or a label 1 for fake. With an appropriate optimization technique, the neural networks of the generator G and discriminator D may be trained to reach an optimal point. The optimal generator G may generate optimized behavior trees. MAC generation machine learning model 108 may output one or more behavior trees 118 consistent with the multimodal input data 116 (i.e., rescue mission), as shown in FIG. 3. In an aspect, the machine learning system 102 may be configured to generate optimized MACs 122, using optimization technique described below in conjunction with FIG. 4.

In this way, computing system 101 may, in the example of FIG. 1, receive multimodal input data 116 within simulation engine 120 configured to simulate solving a predefined problem by a team of AI agents. Simulation engine 120 may be configured to simulate a problem-solving environment. This environment can be anything from a simple maze to a complex cityscape. Each AI agent may be responsible for a specific task, such as navigating the environment, detecting obstacles, or communicating with other AI agents. These agents may communicate with each other to share information and coordinate their actions. Simulation engine 120 may be configured to have a predetermined threshold of success for problem solving. This threshold may be based on a variety of factors, such as the time it takes the AI agents to solve the problem, the number of resources they use, or the quality of the solution. As used herein, the terms “problem solving” and a “solution to the problem” refer to merely selecting a solution to the problem having the highest probability of successfully solving the problem.

In an aspect, computing system 101 may also generate one or more generative neural network models based on multimodal input data 116 and based on the predetermined threshold of success of problem solving in simulation engine 120. Computing system 101 may preprocess multimodal input data 116 to make it compatible with the generative neural network model. Preprocessing may involve, but is not limited to, cleaning the data, removing noise, and transforming it into a format that MAC generation machine learning model 108 can understand. The choice of architecture of MAC generation machine learning model 108 may depend on the specific problem that AI agents are trying to solve. There are many different types of generative neural networks, such as, but not limited to, GANs, Variational AutoEncoders (VAEs), and autoregressive models.

In an aspect, MAC generation machine learning model 108 may output one or more MACs. Each MAC may include recommended behaviors for each of the plurality of AI agents to solve the predefined problem in a manner that is consistent with multimodal input data 116. The different types of optimized MACs 122 generated by the MAC generation machine learning model 108 may capture diverse, explainable, coordinated behavior of a team.

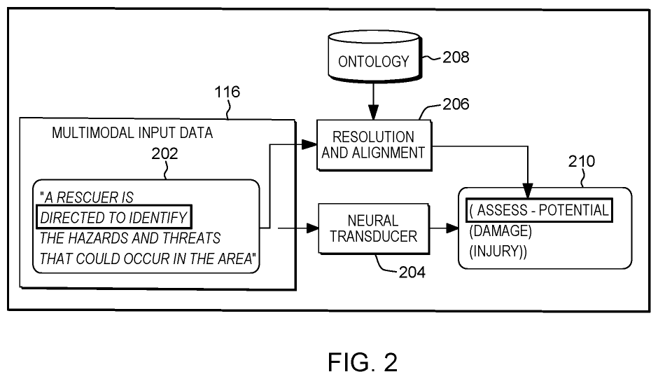

FIG. 2 is a block diagram illustrating conversion, by a semantic parser, of natural language sentences in multimodal input data into Intermediate Representations (TRs) of constraints and/or procedures, according to techniques of this disclosure. In an aspect, AI model 106 may convert natural language sentences 202 contained in multimodal input data 116 into an Intermediate Representation (IR) using a semantic parser that may be configured to convert natural language into logical form. In other words, AI model 106 may parse and interpret multimodal input data 116 to formulate machine processable queries and algorithms.

The semantic parser may be configured to parse domain-specific natural language and convert it into a structured representation. The semantic parser may use a model to produce the structured representation in the form of well-formed expression trees written, for example, in a markup language (e.g., XML, JSON, etc.) to facilitate further processing. The semantic parser may receive a natural language input 116 (e.g., a sentence from multimodal input data 116 written in natural language) and may output a semantic construction of natural language input (sometimes referred to herein as “structured statements”) in a symbolic language output.

In an aspect, AI model 106 may apply a neural sequence transducer 204 to translate structure and to identify arguments and entities. One example of neural sequence transducer 204 is an RNN transducer, which implements an RNN to model the dependency of each output on the previous outputs, thereby yielding a jointly trained language model.

Next, AI model 106 may perform reference resolution and alignment 206 to identify entities and to align them to ontology terms 208 by analyzing text of multimodal input data 116. AI model 106 may determine the similarity relationship between the text subgroups by performing semantic analysis, performing natural language processing, using methods such as tokenization, sentence segmentation, parts-of-speech tagging, named entity recognition, stemming, lemmatization, co-reference resolution, parsing, relation extraction, vector space models, latent semantic analysis, and the like, identifying causal relationships between the text subgroups, determining semantic similarity based on ontology, using a semantic index to compare semantic similarities, determining a statistic similarity, the like, and combinations thereof.

In an aspect, AI model 106 may perform ontology processing 208 and structuring of multimodal input data 116. An ontology is a model of the important entities and relationships in a domain. Ontologies are used in capturing the semantics of a document set. Common components of an ontology include objects, instances, classes, attributes, relations, restrictions, rules, axioms and events. Objects are entities such as a person, a company, a name, etc. Instances are particular instances of an entity. Classes are collections of objects and entities. Attributes are properties and characteristics that an object or a class may have. Relations define how one class, object or entity relates to other classes, objects and entities. Restrictions define the constraints placed on classes, objects and entities. Rules define conditions and results such as those in if-then-else statements, logical inferences, etc. Axioms are logical assertions that define variables in the system, and events cause attributes, relations and axioms to change. IRs 210 may express complex temporal and sequencing behaviors.

FIG. 3 is a block diagram illustrating multi-agent controllers represented as behavior trees, wherein each of behavior trees comprises recommended behaviors, consistent with the multimodal input data, according to techniques of this disclosure. The behavior trees 302 may be generated by the MAC generation machine learning model 108. A behavior tree is a means for describing complex team behavior as a composition of modular sub-actions. In an aspect, behavior trees 302 may contain, but not limited to the following information, sequence in which tasks should be executed, which tasks could be executed in parallel, what to do, who should do it, at what level, and the like. For example, in the context of controlling a team of robots, the task of fetching an object can be described as a sequence of sub-actions for navigating towards the object, detecting it using a camera, picking it up using a gripper, and bringing it to the requested location. Behavior tree 302 may describe the ‘control flow’, i.e., in which order, under which conditions and by which agents these sub-actions are to be executed.

In an aspect, each of the plurality of behavior trees 302 may comprise three kinds of nodes: a root node 304, control flow nodes 306, and execution nodes 308 corresponding to the aforementioned sub-actions. These nodes are connected using directed edges 310. The node with outgoing edge is called “parent”, the node with an incoming edge is called “child”. Each node has at most one parent node and zero or more child nodes. The root node 304 has no parent. Each control flow node 306 has one parent and at least one child, and each execution node 308 has one parent and no child. There are two types of control flow nodes: ‘composite tasks’, which can have multiple child tasks, and ‘decorators’ that wrap a single child task. Execution nodes 308 may also be called the “leaves” of the behavior tree 302.

Each generated BT 302 may normally be traversed with a fixed frequency in a depth-first manner, starting from root node 304. This periodic re-evaluation of BTs 302 facilitates the implementation of reactive behavior. The root node and control flow nodes trigger the execution of their child nodes, usually starting with the first one, and update their own execution status depending on the execution status of their children. Depending on the execution result, they may trigger the execution of another child, e.g., to sequentially execute all children after another. The connections between the nodes in behavior tree 302 specify the control flow, e.g., the order in which the tasks are to be performed.

Each generated BT 302 may be fine-tuned in the context of a concrete scenario (e.g., scenario from a rescue mission 312) using hierarchical reinforcement learning (HRL) in simulation performed by the simulation engine 120. In other words, generated BTs 302 may comprise one or more nodes configured to learn scenario-specific optimal policies. Reinforcement learning is a machine learning method that emphasizes the selection of an action based on the current environmental state such that the action can achieve the maximum expected reward. After training, any generated BT 302 may be consistent with the multimodal input data 116 (e.g., rescue mission 312). In an aspect, each generated BT 302 may comprise an explainable COA. In an aspect, each generated BT 302 may capture the structure of an HRL policy and may represent a learned task decomposition. In an aspect, each of the BTs 302 may represent, in a natural language, at least: one or more goals of a team, one or more behaviors of one or more agents and one or more relationships between the goals of the team and the behaviors of the agents.

FIG. 4 is a flow chart illustrating optimization of the generated plurality of MACs, using a simulation engine, according to techniques of this disclosure. In an aspect, at 402, MAC generation machine learning model 108 may generate one or more MACs. In one non-limiting example, the output of MAC generation machine learning model 108 may be a generalized MAC with some unknown policy decisions determined by free parameters θ that may be fine-tuned for a concrete scenario using simulation performed by simulation engine 120. In an aspect, recommended team behaviors may be generated from the execution of the final MAC. The generated MAC may be consistent with multimodal input data 116. In other words, execution of MACs may generate team behaviors that are consistent with the steps prescribed by multimodal input data 116 (e.g., rescue mission 312).

At 404, simulation engine 120 may execute each of the one or more generated MACs. In an aspect, simulation engine 120 may be configured to perform simulations of entire environments and of events and actors within the environment. Simulation engine 120 may offer a configurable and scalable environment that could support thousands of interactive agents, for example. In an aspect, simulation engine 120 may enact behaviors from generated MACs which dictate a probabilistic behavior for many objects and events in a simulation environment. Results of these actions may be relayed through a network to machine learning system 102 and/or any users or another program that may be connected to simulation engine 120, but users need not be connected to a simulated environment for that environment to progress, with events and objects behaving as they are programmed, without users or actors at a given point.

According to an aspect, at 406, upon receiving results of simulation of generated MACs, machine learning system 102 may pass such results to reward maximization module 109. Reward maximization module 109 may be configured to provide long term optimization of an objective function related to a team behavior. The objective function may be represented as a weighted sum of desired outcomes (e.g., business outcomes), goals, rewards, or payoffs (collectively referred to as “reward” or “expected value”). In general terms, reward maximization module 109 may be configured to maximize the objective function subject to constraints. Specifically, according to an aspect, reward maximization module 102 may be configured to select agents (e.g., team members) for a particular task so as to maximize the long-term reward while balancing exploration and team needs. In this regard, reward maximization module 109 may select optimal agents for a particular task based on contextual information about agents, environment and intent (e.g., a problem that needs to be solved by a team). For example, the reward may be completion of a task. In an aspect, reward maximization module 102 may utilize reinforcement learning to adapt the agent selection strategy to maximize the reward, for example.

In an aspect, at 407, machine learning system 102 may pass results of simulation to fact checking module 110. Fact checking module 110 may be responsible for evaluating the accuracy of simulation results. Fact checking module 110 may use a variety of techniques, such as natural language processing, machine learning, and knowledge bases to assess the credibility of processed/generated information.

At 408, machine learning system 102 may utilize a learning algorithm to update weights of MAC generation machine learning models 108. In an aspect, machine learning system 102 may implement a deep Q-learning approach. An analysis may start with the reinforcement learning setting of an agent interacting in an environment over a discrete number of steps. At time t the agent in state sₜ takes an action at and receives a reward rₜ. The state-value function is the expected return (sum of discounted rewards) from state s following a policy π(a|s). The state-value function may be represented by the following formula (1):

V^{π}(s)= [symbol] [R_{t:∞}|sₜ=s,π] (1).

The action-value function is the expected return following policy π after taking action a from state s. The action-value function may be represented by the following formula (2):

Q^{π}(s,a)= [symbol] [R_{t:∞}|sₜ=s,aₜ=a,π] (2).

In an aspect, machine learning system 102 may approximate the action-value function Q (s, a; θ) using parameters θ, and then update parameters to minimize the mean-squared error, using the loss function. The loss function may be represented by the following formula (3):

$${L}_{Q} ( {θ}_{i} ) = 𝔼 [ {( r + γ {max}_{{a}^{′}} Q ( {s}^{′} , {a}^{′} ; {θ}_{i}^{-} ) - Q ( s , a ; {θ}_{i} ) )}^{2} ] , \qquad ( 3 )$$

where θ⁻ represents the parameters of the target network that is held constant but synchronized to the behavior network θ⁻=θ, at certain periods to stabilize learning. In an aspect, after updating the weights, machine learning system 102 may generate optimized MACs 122.

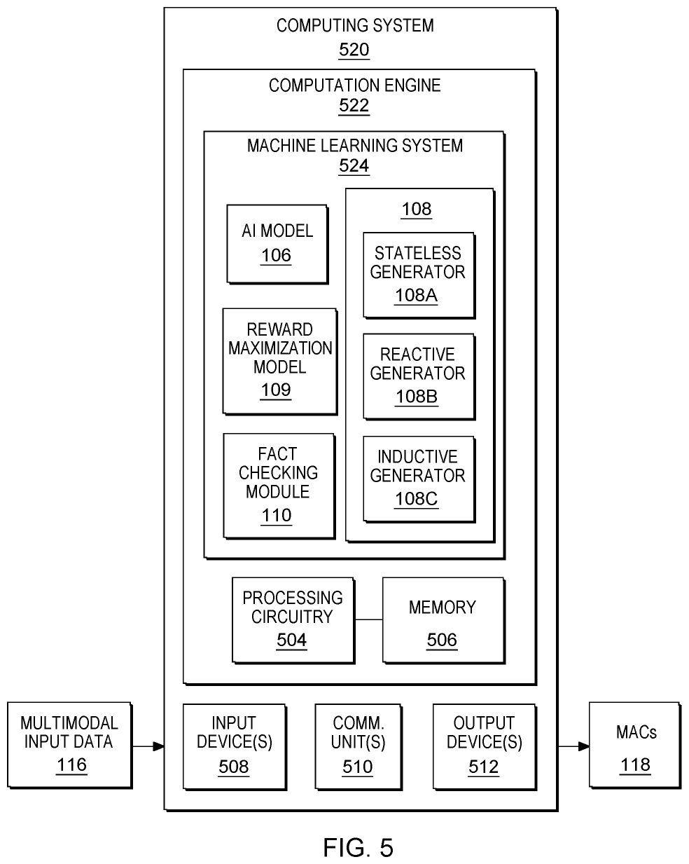

FIG. 5 is an example of a computing system, according to techniques of this disclosure. Computing system 520 represents one or more computing devices configured for executing a machine learning system 524, which may represent an example instance of any machine learning system described in this disclosure, such as machine learning system 102 of FIG. 1. Computing system 520 may comprise any suitable computing system having one or more computing devices, such as desktop computers, laptop computers, gaming consoles, smart televisions, handheld devices, tablets, mobile telephones, smartphones, etc. In some examples, at least a portion of computing system 520 is distributed across a cloud computing system, a data center, and/or across a network, such as the Internet, another public or private communications network, for instance, broadband, cellular, Wi-Fi, and/or other types of communication networks, for transmitting data between computing systems, servers, and computing devices.

Memory 506 may store information for processing during operation of computation engine 522. In some examples, memory 506 may include temporary memories, meaning that a primary purpose of the one or more storage devices is not long-term storage. Memory 506 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 506, in some examples, also include one or more computer-readable storage media. Memory 506 may be configured to store larger amounts of information than volatile memory. Memory 506 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Memory 506 may store program instructions and/or data associated with one or more of the modules described in accordance with one or more aspects of this disclosure. Memory 506 may store weights for parameters for machine learning models, which in this example include AI model 106 and MAC generators 108.

Processing circuitry 504 and memory 506 may provide an operating environment or platform for computation engine 522, which may be implemented as software, but may in some examples include any combination of hardware, firmware, and software. Processing circuitry 504 may execute instructions and memory 506 may store instructions and/or data of one or more modules. The combination of processing circuitry 504 and memory 506 may retrieve, store, and/or execute the instructions and/or data of one or more applications, modules, or software. Processing circuitry 504 and memory 506 may also be operably coupled to one or more other software and/or hardware components, including, but not limited to, one or more of the components illustrated in FIG. 5. Computing system 520 may use processing circuitry 504 to perform operations in accordance with one or more aspects of the present disclosure using software, hardware, firmware, or a mixture of hardware, software, and firmware residing in and/or executing at computing system 520 and may be distributed among one or more devices.

Computation engine 522 may perform operations described using software, hardware, firmware, or a mixture of hardware, software, and firmware residing in and/or executing at computing system 520. Computation engine 522 may execute machine learning system 524 or other programs and modules with multiple processors or multiple devices. Computation engine 522 may execute machine learning system 524 or other programs and modules as a virtual machine or container executing on underlying hardware. One or more of such modules may execute as one or more services of an operating system or computing platform. One or more of such modules may execute as one or more executable programs at an application layer of a computing platform.

One or more input devices 508 of computing system 520 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 512 may generate, transmit, or process output. Examples of output are tactile, audio, visual, and/or video output. Output devices 512 may include a display, sound card, video graphics adapter card, speaker, presence-sensitive screen, one or more USB interfaces, video and/or audio output interfaces, or any other type of device capable of generating tactile, audio, video, or other output. Output devices 512 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 520 may include a presence-sensitive display that may serve as a user interface device that operates both as one or more input devices 508 and one or more output devices 512.

One or more communication units 510 of computing system 520 may communicate with devices external to computing system 520 (or among separate computing devices of computing system 520) by transmitting and/or receiving data, and may operate, in some aspects, as both an input device and an output device. In some examples, communication units 510 may communicate with other devices over a network. In other examples, communication units 510 may send and/or receive radio signals on a radio network such as a cellular radio network. Examples of communication units 510 include a network interface card (e.g., such as an Ethernet card), an optical transceiver, a radio frequency transceiver, a GPS receiver, or any other type of device that can send and/or receive information. Other examples of communication units 510 may include Bluetooth®, GPS, 3G, 4G, and Wi-Fi® radios found in mobile devices as well as Universal Serial Bus (USB) controllers and the like.

Input devices 508 or communication units 510 may receive multimodal input data 116. MAC generators 108 may be used to generate predicted outputs. Computation engine 522 executes and applies machine learning system 524 to multimodal input data 116 to generate predicted outputs in the form of MACs 118. Output devices 512 or communication units 510 outputs MACs 118, which may contain diverse, explainable, interpretable, reactive and coordinated team behaviors.

Although described as being implemented using neural networks in the example of FIG. 5, machine learning system 524 may also or alternatively apply other types of machine learning to train one or more models. For example, machine learning system 524 may apply one or more of nearest neighbor, naïve Bayes, decision trees, linear regression, support vector machines, neural networks, k-Means clustering, temporal difference, deep adversarial networks, or other supervised, unsupervised, or semi-supervised learning algorithms to train one or more models for prediction.

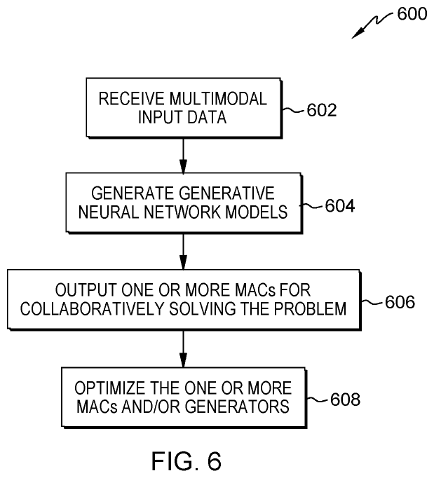

FIG. 6 is a flowchart illustrating an example mode of operation for a machine learning system, according to techniques described in this disclosure. Although described with respect to computing system 520 of FIG. 5 having a computation engine 522 that executes machine learning system 524, mode of operation 600 may be performed by a computation system with respect to other examples of machine learning systems described herein.

In mode of operation 600, computation engine 522 executes machine learning system 524. At 602, machine learning system 524 may receive multimodal input data 116 for solving a problem by a team comprising a plurality of AI agents. In emergency situation context, multimodal input data 116 may be damage assessment, various paths to reach one or more victims, operation orders (a formatted directive that a team leader issues to his/her subordinates describing the actions and tasks required to execute the selected COA), and the like. At 604, machine learning system 524 may generate one or more generative neural network models based on the multimodal input data 116 and based on the predetermined threshold of success of problem solving in the simulation engine 120. Accordingly, machine learning system 524 may generate one or more DNNs, based on the multimodal input data 116. At 606, machine learning system 524 may output one or more MACs (such as behavior trees) for collaboratively solving a problem using the generated one or more neural network models. In step 606, generated MACs 118 may contain, but not limited to the following information: sequence in which tasks should be executed, which tasks could be executed in parallel, what to do, who should do it, at what level, and the like.

At 608, machine learning system 524 may optimize one or more MACs and/or one or more generators 108 using simulation engine 120, as described above.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method comprising:
receiving multimodal input data within a simulator configured to simulate solving a predefined problem by a team comprising a plurality of agents;
generating one or more generative neural network models based on the multimodal input data and based on a predetermined threshold of success of problem solving in the simulator; and
outputting, by the one or more generative neural network models, one or more multi-agent controllers, wherein each of the one or more multi-agent controllers comprises recommended behaviors for each of the plurality of agents to solve the predefined problem in a manner that is consistent with the multimodal input data.

2. The method of claim 1, wherein the one or more generative neural network models comprise one or more Deep Neural Networks (DNNs) having a generator configured to generate the one or more multi-agent controllers.

3. The method of claim 2, wherein the generator comprises at least one of: a stateless generator, a reactive generator and an inductive generator.

4. The method of claim 3, wherein the stateless generator is configured to generate one or more multi-agent controllers that is reactive to dynamic changes in an environment in which the problem is solved.

5. The method of claim 2, wherein the one or more multi-agent controllers comprise one or more behavior trees.

6. The method of claim 5, wherein each of the one or more behavior trees represents, in a natural language, at least: one or more goals of the team, one or more behaviors of one or more of the plurality of agents and one or more relationships between the one or more goals of the team and the one or more behaviors of the one or more of the plurality of agents.

7. The method of claim 5, wherein the generator comprises a Behavior Tree Generative Adversarial Network (BT-GAN).

8. The method of claim 1, wherein generating the one or more generative neural network models further comprises converting, by a semantic parser, natural language sentences in the multimodal input data into one or more Intermediate Representations (IRs) of one or more constraints and/or one or more procedures.

9. The method of claim 5, wherein the one or more behavior trees comprise one or more nodes of the behavior tree configured to learn scenario-specific controllers.

10. A machine learning system for generating team behaviors, the machine learning system comprising:
an input device configured to receive multimodal input data;
processing circuitry and memory for executing a machine learning system,
wherein the machine learning system is configured to generate one or more generative neural network models based on the multimodal input data and based on a predetermined threshold of success of problem solving in a simulator configured to simulate solving a predefined problem by a team comprising a plurality of agents; and
an output device configured to output one or more multi-agent controllers, wherein each of the one or more multi-agent controllers comprises recommended behaviors for each of the plurality of agents to solve the predefined problem in a manner that is consistent with the multimodal input data.

11. The machine learning system of claim 10,
wherein the one or more generative neural network models comprise one or more Deep Neural Networks (DNNs) having a generator configured to generate the one or more multi-agent controllers.

12. The machine learning system of claim 11, wherein the generator comprises at least one of: a stateless generator, a reactive generator and an inductive generator.

13. The machine learning system of claim 12,
wherein the reactive generator is configured to generate one or more multi-agent controllers that is reactive to dynamic changes in an environment in which the problem is solved.

14. The machine learning system of claim 11,
wherein the one or more multi-agent controllers comprise one or more behavior trees.

15. The machine learning system of claim 14,
wherein each of the one or more behavior trees represents, in a natural language, at least: one or more goals of the team, one or more behaviors of one or more of the plurality of agents and one or more relationships between the one or more goals of the team and the one or more behaviors of the one or more of the plurality of agents.

16. The machine learning system of claim 14,
wherein the generator comprises a Behavior Tree Generative Adversarial Network (BT-GAN).

17. The machine learning system of claim 10,
wherein the machine learning system configured to generate the one or more generative neural network models is further configured to convert, by a semantic parser, natural language sentences in the multimodal input data into one or more Intermediate Representations (IRs) of one or more constraints and/or one or more procedures.

18. The machine learning system of claim 14,
wherein the one or more behavior trees comprise one or more nodes of the behavior tree configured to learn scenario-specific controllers.

19. A non-transitory computer-readable medium comprising machine readable instructions for causing processing circuitry to perform operations comprising:
receiving multimodal input data within a simulator configured to simulate solving a predefined problem by a team comprising a plurality of agents;
generating one or more generative neural network models based on the multimodal input data and based on a predetermined threshold of success of problem solving in the simulator; and
outputting, by the one or more generative neural network models, one or more multi-agent controllers, wherein each of the one or more multi-agent controllers comprises recommended behaviors for each of the plurality of agents to solve the predefined problem in a manner that is consistent with the multimodal input data.

20. The non-transitory computer-readable medium of claim 19,
wherein the one or more generative neural network models comprise one or more Deep Neural Networks (DNNs) having a generator configured to generate the one or more multi-agent controllers.
